(19) United States
(12) Patent Application Publication
(10) Pub. No.: US 2019/0242191 A1
(43) Pub. Date: Aug. 8, 2019

(54) Polycrystalline Diamond Compact Cutter with Low Cobalt Content Cemented Tungsten Carbide Substrate

(71) Applicant: Wenhui Jiang, Pearland, TX (US)

(72) Inventor: Wenhui Jiang, Pearland, TX (US)

(21) Appl. No.: 16/240,751

(22) Filed: Jan. 6, 2019

Related U.S. Application Data
(60) Provisional application No. 62/626,906, filed on Feb. 6, 2018.

(51) Int. Cl. E21B 10/573; C04B 37/02; C22C 29/08; C22C 26/00; B22F 7/06

(52) U.S. Cl. CPC E21B 10/5735; C04B 37/021; B22F 2005/001; C22C 26/00; B22F 7/06; C22C 29/08

(57) ABSTRACT

The present invention relates to a polycrystalline diamond compact cutter with a low cobalt content cemented tungsten carbide substrate having a coating covering at least a portion of the carbide substrate and the method of making the same. The carbide substrate has a content of three to ten percent by weight on average of cobalt or its alloy as a binder. The coating covers at least partially the exterior surfaces of the carbide substrate, and it may extend over partially or entirely the polycrystalline diamond table. The coating is either a single layer or multilayer. The coating comprises at least a metallic layer. The coating has a thickness of 0.1 μm-100 μm. The coating may have a metallurgical bonding with the polycrystalline diamond compact cutter. Methods for preparing such coating comprise physical vapor deposition, chemical vapor deposition, thermoreactive deposition and diffusion, electrical plating, electroless plating, or their combinations.

### CROSS-REFERENCE TO RELATED APPLICATION

This application claims the benefit of U.S. Provisional Patent Application Ser. No. 62/626,906, filed on Feb. 6, 2018, titled “Polycrystalline Diamond Compact Cutter with Low Metal Content Cemented Carbide Substrate,” the disclosure of which is incorporated herein in its entirety by this reference.

### BACKGROUND OF THE INVENTION—PRIOR ART

The following is a tabulation of some prior arts that presently appear relevant:

U.S. Patents

| Patent Number | Kind Code | Issue Date | Patentee |
|---|---|---|---|
| 6,592,985 | B2 | 2003 Jul. 15 | Griffin et al. |
| 6,878,447 | B2 | 2005 Apr. 12 | Griffin et al. |

U.S. Patent Application Publications

| Publication Nr. | Kind Code | Publication Date | Applicant |
|---|---|---|---|
| 20050262774 | A1 | 2005 Dec. 1 | Eyre et al. |
| 20160017665 | A1 | 2016 Jan. 21 | Beaton |

### BACKGROUND OF THE INVENTION

The present disclosure relates to polycrystalline diamond compact (PDC) cutter used in various cutting, mining, grinding, as well as drilling tools such as drilling bits, milling bits, and reamers for earth exploration and production. The PDC cutter consists of a polycrystalline diamond (PCD) table and a cemented carbide substrate. More specifically, the present disclosure relates to the PDC cutter with the cemented tungsten carbide substrate having a low cobalt binder content and a coating covering at least a portion of the cemented carbide substrate. The PDC cutter with the low cobalt content cemented tungsten carbide substrate has reduced residual stresses at the interface between the PCD table and the cemented carbide substrate, and increased erosion and wear resistance.

PDC cutters are well known in prior arts. They comprise a table of PCD as a cutting element and a cemented carbide body as a cutter substrate. They are typically cylindrical in shape. The PDC cutters are formed by sintering and bonding together relatively small diamond grains under conditions of high temperature and high pressure in the presence of a catalyst (for example, cobalt, nickel, iron, or alloys or mixtures thereof) to form a layer of PCD materials on a cutter substrate. These processes are often referred to as high-temperature/high-pressure (HTHP) processes. The cutter substrate comprises a cemented carbide material such as cobalt-sintered tungsten carbide. In such the instances, cobalt (or other catalyst material) in the cutter substrate may sweep or diffuse into the diamond particles during sintering and serve as the catalyst material for forming the intergranular diamond-to-diamond (D-D) bonds, and the resulting diamond table, from the diamond grains. In other methods, powdered catalyst material may be mixed with diamond particles prior to sintering the particles together in an HTHP process.

Alternatively, a PDC cutter can be formed by brazing an unbacked PCD onto a cemented carbide material substrate. The unbacked PCD can be formed by sintering individual diamond particles together in an HTHP process in the presence of a catalyst/solvent that promotes D-D bonding, as described previously.

Thermally stable polycrystalline diamond compact (TSPDC) cutters refer herein to the PDC cutters that have a thermally stable PCD table that contains none or a reduced amount of catalyst materials such as cobalt. Usually, a leaching process is used to remove the catalyst materials in a PCD table via a chemical or an electrochemical process. A caustic material such as acids or bases may be used as a leaching agent. The leaching process may be performed on a PCD table of a PDC cutter or on an unbacked PCD formed by HTHP. For the latter, the leached unbacked PCD may be subsequently brazed to a cemented carbide substrate forming a TSPDC cutter. Removal of catalyst materials such as cobalt would improve thermal resistance of a PDC cutter substantially, as the catalyst materials would favor graphitization of diamond and develop thermal stresses due to significant difference in coefficient of thermal expansion (CTE) between them and diamond. Usually, leaching a PDC cutter is just to remove catalyst materials around a surface and subsurface layer of a PCD table, that is, partial leaching, while the rest unleached volume of the PCD layer remains intact, which keeps a good toughness of the PDC cutter. A leaching depth is generally tens to hundreds of micrometers from the exterior surfaces of a PCD table. Typical arts in this partial leaching PCD endeavor include U.S. Pat. Nos. 6,592,985 B2 and 6,878,447 B2, which are herein incorporated by reference in their entirety.

It is common practice to braze PDC cutters as cutting components onto various tools such as drilling tools including drilling bits, milling bits, reamers, etc. Although the PDC cutters are very successful as a cutting component in various cutting tools, their premature failure still affects their production yield, performance, and efficiency of cutting tools. The premature failure of the PDC cutters includes chipping, fracturing, cracking, exfoliating or delamination of the PCD layer during HTHP processes, brazing processes, and cutting application. These issues are usually caused by the residual stresses generated at the interface between the PCD table and the cemented carbide substrate, as there is a significant difference in CTE between them.

The present disclosure has a primary objective of reducing residual stresses at the interface between the PCD table and the cemented carbide substrate of a PDC cutter, increasing impact toughness, enhancing erosion and wear resistance, and improving brazability, so as to enhance the qualities of the PDC cutter, increase its production yield, avoid premature failure, and prolong service life of cutting tools.

### SUMMARY OF THE INVENTION

The present disclosure relates to a polycrystalline diamond compact (PDC) cutter with a low cobalt content cemented tungsten carbide substrate which has a coating covering at least a portion of the exterior surface of the cemented carbide substrate. The PDC cutter consists of a polycrystalline diamond (PCD) table which is either unleached or leached, and a coated cemented tungsten carbide body substrate with a low cobalt content.

The cemented tungsten carbide substrate has a content of three to ten percent by weight on average of cobalt or its alloys. The cobalt (Co) or its alloys act as a binder in the cemented tungsten carbide. The PDC cutter with the low cobalt content cemented tungsten carbide substrate has reduced residual stresses at the interface between the PCD table and the cemented carbide substrate.

The coating covers at least a portion of the low cobalt content cemented tungsten carbide substrate and may extend to cover partially or entirely the exterior surface of the PCD layer. The coating comprises a metal or alloy layer which is selected from nickel (Ni), iron (Fe), cobalt (Co), titanium (Ti), niobium (Nb), zirconium (Zr), vanadium (V), tantalum (Ta), hafnium (Hf), chromium (Cr), tungsten (W), molybdenum (Mo), manganese (Mn), silver (Ag), copper (Cu), gold (Au), platinum (Pt), palladium (Pd), and the alloys containing any of these metals. The metal coating would improve brazability of PDC cutter due to their excellent wettability. The coating may have a metallurgical bonding with the PDC cutter. The metallurgical bonding is achieved either during deposition processes, additional heat treatments, or subsequent brazing operations when joining to a tool body.

The coating processes comprise various deposition methods such as physical vapor deposition (PVD), chemical vapor deposition (CVD), thermoreactive deposition and diffusion (TD), electrolytic plating, electroless plating, and their combinations.

### BRIEF DESCRIPTION OF THE DRAWING

FIG. 1 is a schematic illustration of a cross sectional view of a cylindrical PDC cutter consisting of a PCD table and a cemented tungsten carbide body substrate with a low cobalt content.

FIG. 2 is a schematic illustration of a cross sectional view of a cylindrical PDC cutter having a coating covering all the exterior surfaces of the cemented tungsten carbide substrate with the low cobalt content.

FIG. 3 is a schematic illustration of a cross sectional view of a cylindrical PDC cutter having a coating covering the side surfaces of the cemented tungsten carbide substrate with the low cobalt content.

FIG. 4 is a schematic illustration of a cross sectional view of a cylindrical PDC cutter having a coating covering all the exterior surfaces of the PCD table and the side surface of the cemented tungsten carbide substrate with the low cobalt content.

FIG. 5 is a schematic illustration of a cross sectional view of a cylindrical PDC cutter having a coating over all the exterior surfaces of the PDC cutter including the PCD table and the cemented tungsten carbide body substrate with the low cobalt content.

### DRAWING—REFERENCE NUMERALS

10 cemented tungsten carbide substrate with low cobalt content

12 PCD table

14 coating

### DETAILED DESCRIPTION OF THE INVENTION

Embodiments of the disclosure relate to a polycrystalline diamond compact (PDC) cutter with a low cobalt content cemented tungsten carbide substrate having a coating covering at least a portion of the exterior surfaces of the cemented carbide substrate. A PDC cutter comprises a table of polycrystalline diamond (PCD) materials as a cutting element and a cemented tungsten carbide body as a cutter substrate. The PDC cutter is formed by sintering and bonding together relatively small diamond particles under conditions of high temperature and high pressure (HTHP) in the presence of a catalyst to form a table of PCD on a cutter substrate. The cutter substrate comprises a cemented carbide material such as cobalt-sintered tungsten carbide. In such the instances, the cobalt (or other catalyst material) in the cutter substrate may sweep or diffuse into the diamond particle compacts during sintering and serve as the catalyst material for forming the inter-granular diamond-to-diamond (D-D) bonds, and the resulting PCD table, from the diamond particles. In other methods, powdered catalyst material may be mixed with the diamond particles prior to sintering the particles together in an HTHP process. Alternatively, a PDC cutter can be formed by brazing an unbacked PCD layer onto a cemented material substrate. The unbacked PCD can be formed by sintering individual diamond particles together in an HTHP process in the presence of a catalyst that promotes D-D bonding, as described previously.

According to this disclosure, a cemented tungsten carbide substrate of a PDC cutter is referred to as a cobalt-sintered tungsten carbide compact. It is a composite material of tungsten carbide particles and cobalt or its alloy. The cobalt or its alloy act as a binder of a cobalt-sintered tungsten carbide compact. The sintered tungsten carbide compacts can be either straight grade sintered tungsten carbide composites in which tungsten carbide is the sole carbide constituent, or those straight grade sintered tungsten carbide composites combined with varying proportions of other carbides such as titanium carbide (TiC), tantalum carbide (TaC), niobium carbide (NbC), etc.

According to this disclosure, the low cobalt content cemented tungsten carbide substrate of a PDC cutter has a content of three to ten percent by weight on average of cobalt or its alloys. The cobalt or its alloys act as a binder of the cemented tungsten carbide substrate.

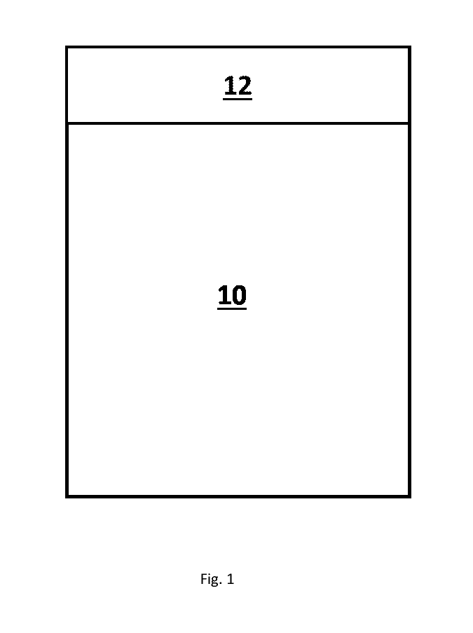

According to this disclosure, FIG. 1 schematically shows a cross sectional view of a PDC cutter with a low cobalt content cemented tungsten carbide substrate. The PDC cutter comprises a low cobalt content cemented tungsten carbide body 10 as a supporting substrate and a PCD table 12 as a cutting element, such as those discussed above.

According to this disclosure, the PDC cutter is either an unleached or a leached PDC cutter. The unleached PDC cutter refers to a conventional PDC cutter whose PCD table comprises inter-bonded diamond particles and catalytic materials such as Co. Its thermal stability usually is not higher than 750° C. The leached PDC cutter refers to a kind of thermally stable PDC (TSPDC) cutters whose PCD table comprises inter-bonded diamond particles, and none or a reduced amount of catalytic materials such as Co that are leached out using acids or bases. The leached PDC cutter usually contains none or a reduced amount of catalytic materials only around the surface and subsurface layer of its PCD layer, since a completely leached PCD is very brittle. Usually, a leaching depth is tens to hundreds of micrometers from the exterior surfaces of a PCD table. The leached PDC cutter has excellent resistance to thermal damages. Typical arts in this partial leaching PCD endeavor include U.S. Pat. Nos. 6,592,985 B2 and 6,878,447 B2, which are herein incorporated by reference in their entirety.

Embodiments of the disclosure relate to a PDC cutter with a low cobalt content cemented tungsten carbide substrate having a coating covering at least a portion of the exterior surfaces of the cemented tungsten carbide substrate. The low cobalt content cemented tungsten carbide substrate of the PDC cutter has a content of three to ten percent by weight on average of cobalt or its alloys as a binder. A cemented tungsten carbide substrate of a conventional PDC cutter usually has a cobalt binder content of 11-16% by weight on average. Since there is significant difference in coefficient of thermal expansion (CTE) between cobalt binder and diamond, a cobalt binder content in a cemented tungsten carbide substrate would affect substantially thermal mismatch at the interface between a PCD table and a cemented tungsten carbide substrate of a PDC cutter. The higher the cobalt binder content in the cemented tungsten carbide substrate, the more severe the thermal mismatch. The severe thermal mismatch would generate high residual stresses after their HTHP manufacturing processes and during brazing. As a result, the high residual stresses may cause numerous issues of quality and performance of a PDC cutter, such as chipping, fracturing, cracking, exfoliating or delamination of the PCD table during HTHP processes, brazing processes, as well as cutting application. The PDC cutter with the low cobalt content cemented tungsten carbide substrate has low residual stresses at the interface between the PCD table and the cemented tungsten carbide substrate, and thus, improve its production yield and application performance. Furthermore, the low cobalt content cemented tungsten carbide substrate also has higher erosion and wear resistance, as it has a higher hardness. This would benefit the performance of PDC cutters and cutting tools. Applicant discovered that a low cobalt content in a cemented tungsten carbide substrate of a PDC cutter not only reduced cracking during HTHP processes and brazing operations when mounted to a tool, but also improved impact resistance. In U.S. Appl. Pat. No. 2016/0,017,665 A1, which are herein incorporated by reference in their entirety, it is stated that having a cobalt content in a tungsten carbide substrate between six and ten percent by weight has not resulted in increased incidence of brittle failure.

Embodiments of the disclosure relate to a PDC cutter with a low cobalt content cemented tungsten carbide substrate having a coating. The coating covers at least a portion of the low cobalt content cemented tungsten carbide substrate. The reduction in the cobalt binder content of a cemented tungsten carbide would impair its brazability. The coating on the low cobalt content cemented tungsten carbide substrate would improve its brazability and increase the bonding strength between PDC cutters and a tool body. Applicant observed that a low cobalt content cemented tungsten carbide substrate of a PDC cutter has a poor wettability with a silver-based brazing alloy, resulting in a reduced bonding strength between the PDC cutters and a tool body.

According to the disclosure, the coating covers at least a portion of the low cobalt content cemented tungsten carbide substrate and may extend to cover partially or entirely the exterior surface of the PCD table.

According to the disclosure, the coating comprises a layer of a metal or alloy selected from nickel (Ni), iron (Fe), cobalt (Co), titanium (Ti), niobium (Nb), zirconium (Zr), vanadium (V), tantalum (Ta), hafnium (Hf), chromium (Cr), tungsten (W), molybdenum (Mo), manganese (Mn), silver (Ag), copper (Cu), gold (Au), platinum (Pt), palladium (Pd), or the alloys containing any of these metals.

According to the disclosure, the coating may comprise multiple layers. The outer layer of the multilayer coating must be a metallic layer which is selected from Ni, Fe, Co, Ti, Nb, Zr, V, Ta, Hf, Cr, W, Mo, Mn, Ag, Cu, Au, Pt, Pd, or the alloys containing any of these metals.

According to the disclosure, the coating may comprise multiple layers. The multilayer coating may comprise a layer of a carbide-forming metal or alloy selected from Ti, Nb, Zr, V, Ta, Hf, Cr, W, Mo, or the alloys containing any of these metals as an inner layer, which is held in contact with a PDC cutter.

According to the disclosure, the multilayer coating may comprise a compound layer. The compound comprises carbides, nitrides, borides, oxides, or their complex compounds. The compound preferentially contains aluminum, chromium, or both, such as AlN, CrN, AlTiN, AlCrN, AlTiSiN, or TiAlCrYN. The compound layer has excellent oxidation and erosion resistance. It can protect a PDC cutter from thermal and mechanical attacks during brazing and cutting application.

According to the disclosure, the coating may have a metallurgical bonding with a PDC cutter. The metallurgical bonding is achieved either during deposition processes, additional heat treatments, or subsequent brazing operations when joining to a tool body.

According to this disclosure, a heat treatment may be employed to form metallurgical bonding at the interface between a coating and a PDC cutter. The heat treatment is carried out in a vacuum, an inert, or reduced gas protective furnace at 450° C.-900° C. for 1 minutes to 120 minutes.

According to this disclosure, a coating thickness is in a range of 0.1 μm-100 μm, preferentially 1 μm-10 μm.

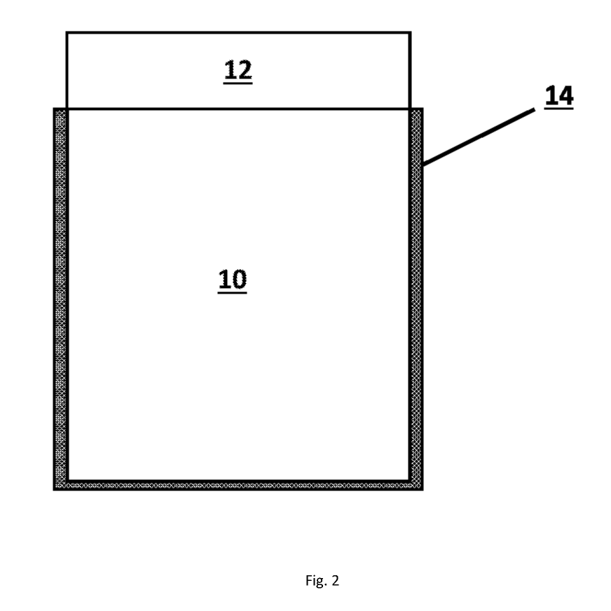

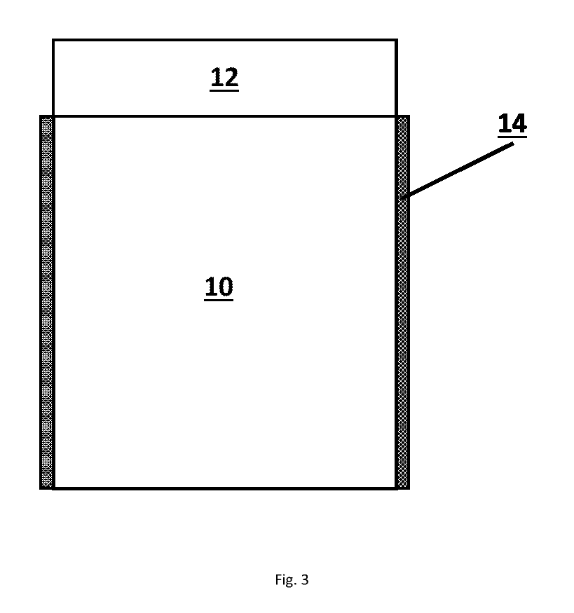

Referring to FIG. 2, another embodiment of a PDC cutter with a low cobalt content cemented tungsten carbide substrate having a coating over its the cemented carbide substrate in accordance with the present disclosure is shown. FIG. 2 schematically shows a cross sectional view of a PDC cutter with a low cobalt content cemented tungsten carbide substrate having a coating over all the exterior surfaces. As shown, the low cobalt content cemented tungsten carbide substrate 10 has a coating 14 over all the exterior surfaces. The cemented carbide body 10 is the substrate of the PCD table 12. It should be apparent that the layer illustrated in FIG. 2 is exaggerated in thickness for purposes of illustration, and in practice it is extremely thin. The similar illustrations are also in FIGS. 3-5.

Referring to FIG. 3, another embodiment of a PDC cutter with a low cobalt content cemented tungsten carbide substrate having a coating over a portion of its exterior surfaces in accordance with the present disclosure is shown. FIG. 3 schematically shows a cross sectional view of a PDC cutter with a low cobalt content cemented tungsten carbide substrate having a coating over its side surfaces. As shown, the low cobalt content cemented tungsten carbide substrate 10 has a coating 14 covering its side surfaces. The cemented carbide body 10 is the substrate of the PCD table 12.

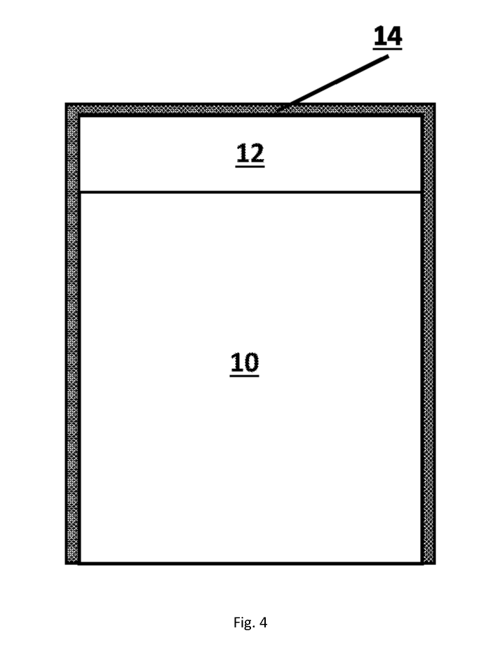

Referring to FIG. 4, another embodiment of a PDC cutter with a low cobalt content cemented tungsten carbide substrate having a coating over a portion of the exterior surfaces of the carbide substrate and the PCD layer in accordance with the present disclosure is shown. FIG. 4 schematically shows a cross sectional view of a PDC cutter having a coating over the side surfaces of the carbide substrate and all the exterior surfaces of the PCD table. As shown, the low cobalt content cemented tungsten carbide substrate 10 has a coating 14 covering its side surfaces, and the PCD table 12 has a coating 14 covering all the exterior surfaces. The cemented carbide body 10 is the substrate of the PCD table 12.

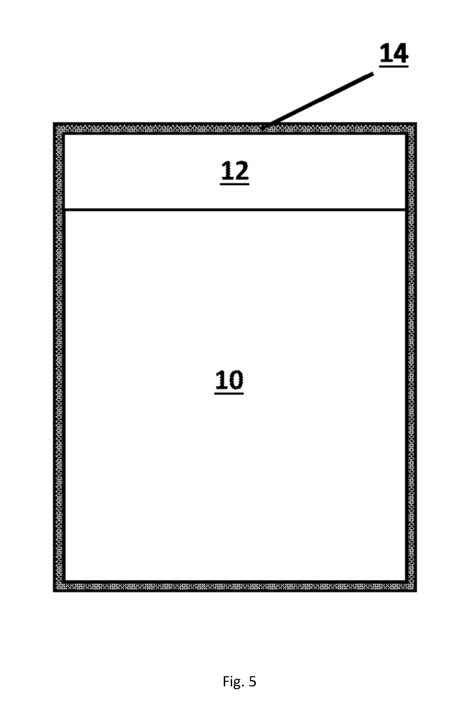

Referring to FIG. 5, another embodiment of a PDC cutter with a low cobalt content cemented tungsten carbide substrate having a coating over all the exterior surfaces of the PDC cutter in accordance with the present disclosure is shown. FIG. 5 schematically shows a cross sectional view of a PDC cutter having a coating over all the exterior surfaces. As shown, both the low cobalt content cemented tungsten carbide substrate 10 and the PCD table 12 have a coating 14 covering all the exterior surfaces. The cemented carbide body 10 is the substrate of the PCD table 12.

According to this disclosure, a coating may cover the exterior surfaces of a PDC cutter partially or completely. Furthermore, the PDC cutter may have different coatings at various locations. For example, a PCD table of a PDC cutter has a two-layer coating and its cemented carbide substrate has a single-layer metallic coating, or a three-layer metal-compound-metal coating.

According to this disclosure, a PDC cutter may have various geometric shapes including symmetrical and non-symmetrical shapes, such as cylinders, cones, cubes, cuboids, etc.

According to this disclosure, a coating process can be one of physical vapor deposition (PVD), chemical vapor deposition (CVD), thermoreactive deposition and diffusion (TD), electrolytic plating, electroless plating, or their combinations.

PVD is conducted at a relatively low temperature, usually below 500° C. It is an ideal deposition method for coating PDC cutters.

CVD technique utilizes a high temperature process, up to 1000° C. However, PDC cutters have risk of thermal degradation above 700° C. Therefore, processing parameters must be selected carefully, so as to avoid any thermal damages to a PDC cutter during the deposition processes, as its PCD table and cemented carbide substrate have significant difference in CTE.

TD techniques include salt bath immersion and pack cementation methods. They are conducted at high temperatures between 500° C. and 1250° C. Likely, processing parameters must be selected carefully when processing temperature is over 700° C., so as to avoid any thermal damages to a PDC cutter during the deposition processes.

Electrolytic plating and electroless plating are performed in an electrolyte solution at a temperature less than 100° C. A part to be plated must be an electric conductor. Therefore, electrolytic plating and electroless plating could not be applied directly to a PCD table, as the PCD table is not electrically conductive. The plating methods are only suitable to coat a PCD with a prior coating layer.

Examples are provided below to illustrate the working of the embodiments, but such the examples are by no means considered restrictive.

### EXAMPLE 1

### Synthesis of PDC Cutters with Low Cobalt Content Cemented Tungsten Carbide Substrates

1313 PDC cutters with low cobalt content cemented tungsten carbide substrates are synthesized under HTHP processes. The 1313 PDC cutters are cylindrical, and have a nominal diameter of 13 mm and a nominal overall length of 13 mm. A thickness of their PCD tables is about 2 mm and a height of their cemented carbide substrates is approximately 11 mm. The cemented tungsten carbide substrates are straight grade sintered tungsten carbide with a cobalt binder. They have a nominal chemical composition of 91% WC and 9% Co by weight. The HTHP processes are conducted at 1450° C.-1550° C. and under 5 GPa-6 GPa. The production yield is 100%.

### EXAMPLE 2

### Coating the PDC Cutters with Three Layers of Cr, AlTiN, and NiCr by PVD-Ion Plating

The 1313 PDC cutters that are synthesized in Example 1 are used for coating. The PDC cutters are subjected to ion plating processing to deposit Cr, AlTiN, and NiCr alloy over the side surfaces of the cemented tungsten carbide substartes and all the exterior surfaces of the PCD tables. Ion plating is one of PVD processes that is also referred to as ion assisted deposition. The PDC cutters are rinsed ultrasonically in acetone, dried, and then put into a chamber of an ion plating machine. There are three kinds of targets in the chamber, that is Cr, AlTi alloy, and NiCr alloy. First, a bonding layer Cr was deposited onto the PDC cutters by burning the Cr target by trigger. A partial pressure of Ar was kept at 0.5 Pa. The deposition temperature is around 450° C. and the deposition time is 30 min. The Cr coating thickness is about 1 μm. The PDC cutters with the Cr coating are further coated with AlTiN by burning the AlTi alloy target. At this time, nitrogen gas was introduced into the chamber by a mass flow meter. The deposition temperature is around 450° C. and the deposition time is 1.5 hours. The coating thickness of AlTiN is about 4 μm. Finally, an outer layer NiCr alloy is deposited onto the AlTiN layer by burning the NiCr target by trigger. A partial pressure of Ar was kept at 0.5 Pa. The deposition temperature is around 450° C. and the deposition time is 30 min. The outer layer of NiCr has a thickness of about 1 μm. The coating on the PDC cutters has three layers. The inner coating layer is the Cr bonding layer, the intermediate layer is the oxidation- and wear-resistant layer of AlTiN compound, and the outer brazable layer is the NiCr alloy layer. The coatings are continuous, dense, and crack free.

### EXAMPLE 3

### Heat Treatment of the Coated PDC Cutters

The PDC cutters with the three-layer coating of Example 2 are subject to heat treatment. The heat treatment is performed in an electric resistance furnace under flowing Ar. The heating rate is 10° C./min. The predetermined holding temperature is 630° C. and the predetermined holding time is 1 hour. The PDC cutters are cooled in the furnace by turning off the power while keeping Ar flowing. The heat treatment is to achieve a metallurgical bonding between the PDC cutters and the coating layers. The coating is continuous, dense, and crack free.

### EXAMPLE 4

### Brazing the coated PDC Cutters

The PDC cutters with the three-layer coating of Example 3 are subject to brazing processes. A brazing alloy has a nominal chemical composition of consists of 56% Ag, 22% Cu, 17% Zn, 5% Sn by weight, whose solidus and liquidus are 620° C. and 650° C., respectively. A flame torch is used for heating. It is estimated that a brazing temperature is 650° C.-750° C. The coated PDC cutters are brazed onto a steel coupon. Mechanical testing demonstrates that average bonding strength of the coated PDC cutters is about 15% higher than that of uncoated PDC cutters with the low cobalt content cemented tungsten carbide substrates of 91% WC-9% Co by weight. No cracking is observed on all the brazed PDC cutters. The brazable metal coating improves brazability of the PDC cutters with the low cobalt content cemented tungsten carbide substrates.

According to this disclosure, a PDC cutter with a low cobalt content cemented tungsten carbide substrate having a coating covering at least a portion of the cemented carbide substrate is mounted to a cutting tool body as a cutting component, such as drilling tools including drilling bits, milling bits, reamers, etc. The joining method is brazing operations.

According to this disclosure, a PDC cutter with a low cobalt content cemented tungsten carbide substrate would have reduced residual stresses at the interfaces between the PCD tables and the cemented carbide substrates. Thus, the quality, the production yield, as well as the application performance of the PDC cutters would be improved. The coating on the PDC cutter would improve their brazability and enhance the bonding strength between the PDC cutter and a tool body. Furthermore, the coating would mitigate thermal damages of the PDC cutter during brazing operations, and improve corrosion and erosion resistance during applications. The overall manufacturing and processing methods of a PDC cutter with a low cobalt content cemented tungsten carbide substrate having a coating are convenient, cost-effective, and suitable for mass production.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention as claimed.

1. A polycrystalline diamond compact cutter comprising:
a cemented tungsten carbide body as a supporting substrate, wherein the content of cobalt or its alloy as a binder in the carbide substrate is three to ten percent by weight on average;
an unleached or leached polycrystalline diamond table as a cutting element; and
a coating covering at least partially the exterior surfaces of the cemented carbide substrate.

2. The polycrystalline diamond compact cutter as defined in claim 1, wherein the cemented tungsten carbide substrate can be either straight grade sintered tungsten carbide composites in which tungsten carbide is the sole carbide constituent, or those straight grade sintered tungsten carbide composites combined with varying proportions of other carbides such as titanium carbide (TiC), tantalum carbide (TaC), niobium carbide (NbC), etc.

3. The polycrystalline diamond compact cutter as defined in claim 1, wherein the coating comprises a layer of a metal or alloy selected from Ni, Fe, Co, Ti, Nb, Zr, V, Ta, Hf, Cr, W, Mo, Mn, Ag, Cu, Au, Pt, Pd, and the alloys containing any of these metals as an outer layer.

4. The polycrystalline diamond compact cutter as defined in claim 1, wherein the coating comprises a layer of a carbide-forming metal or alloy selected from Ti, Nb, Zr, V, Ta, Hf, Cr, W, Mo, and the alloys containing any of these metals as an inner layer, which is held in contact with the polycrystalline diamond compact cutter.

5. The polycrystalline diamond compact cutter as defined in claim 1, wherein the coating comprises a layer of a compound selected from carbides, nitrides, borides, oxides, and their complex compounds.

6. The polycrystalline diamond compact cutter as defined in claim 1, wherein a metallurgical bonding between the coating and the polycrystalline diamond compact cutter is developed during either deposition processes, heat treatments, or brazing operations when mounted onto a tool.

7. The polycrystalline diamond compact cutter as defined in claim 6, wherein the heat treatments are performed at between 450° C. and 900° C. for 1 minute-120 minutes.

8. The polycrystalline diamond compact cutter as defined in claim 1, wherein the coating has a thickness of 0.1 μm-100 μm, preferentially 1 μm-10 μm.

9. The polycrystalline diamond compact cutter as defined in claim 1, wherein the coating may cover entirely the exterior surfaces of the cemented tungsten carbide substrate, and may extend over partially or entirely the exterior surfaces of the polycrystalline diamond table.

10. Methods of coating a polycrystalline diamond compact cutter comprising an unleached or leached polycrystalline diamond table and a cemented tungsten carbide substrate, comprising physical vapor deposition, chemical vapor deposition, thermoreactive deposition and diffusion, electrolytic plating, electroless plating, or their combinations; wherein content of cobalt or its alloy of the cemented tungsten carbide substrate is three to ten percent by weight on average; and wherein at least a portion of the cemented carbide substrate has a coating.

11. The methods as defined in claim 10, wherein the cemented tungsten carbide substrate can be either straight grade sintered tungsten carbide composites in which tungsten carbide is the sole carbide constituent, or those straight grade sintered tungsten carbide composites combined with varying proportions of other carbides such as titanium carbide (TiC), tantalum carbide (TaC), niobium carbide (NbC), etc.

12. The methods as defined in claim 10, wherein the coating comprises a layer of a metal or alloy selected from Ni, Fe, Co, Ti, Nb, Zr, V, Ta, Hf, Cr, W, Mo, Mn, Ag, Cu, Au, Pt, Pd, and the alloys containing any of these metals as an outer layer.

13. The methods as defined in claim 10, wherein the coating comprises a layer of a carbide-forming metal or alloy selected from Ti, Nb, Zr, V, Ta, Hf, Cr, W, Mo, and the alloys containing any of these metals as an inner layer, which is held in contact with the polycrystalline diamond compact cutter.

14. The methods as defined in claim 10, wherein the coating comprises a layer of a compound selected from carbides, nitrides, borides, oxides, and their complex compounds.

15. The methods as defined in claim 10, wherein a metallurgical bonding between the coating and the polycrystalline diamond compact cutter is developed during either deposition processes, heat treatments, or brazing operations when mounted onto a tool.

16. The methods as defined in claim 15, wherein the heat treatments are performed at between 450° C. and 900° C. for 1 minute-120 minutes.

17. The method as defined in claim 10, wherein the coating has a thickness of 0.1 μm-100 μm, preferentially 1 μm-10 μm.

18. The methods as defined in claim 10, wherein the coating may cover entirely the exterior surfaces of the cemented tungsten carbide substrate, and may extend over partially or entirely the exterior surfaces of the polycrystalline diamond table.
